(19) United States
(12) Patent Application Publication
(10) Pub. No.: US 2014/0282578 A1
(43) Pub. Date: Sep. 18, 2014

(54) LOCALITY AWARE WORK STEALING RUNTIME SCHEDULER

(71) Applicants: Justin S. Teller, Beaverton, OR (US); Sagnak Tasirlar, Houston, TX (US); Romain E. Cledat, Portland, OR (US)

(72) Inventors: Justin S. Teller, Beaverton, OR (US); Sagnak Tasirlar, Houston, TX (US); Romain E. Cledat, Portland, OR (US)

(21) Appl. No.: 13/826,006

(22) Filed: Mar. 14, 2013

(51) Int. Cl. G06F 9/50

(52) U.S. Cl. CPC G06F 9/5033
USPC 718/104

(57) ABSTRACT

In one embodiment a processor comprises logic to determine a center of mass of a plurality of data dependencies associated with a task and assign the task to a processor in the system which is closest to the center of mass. Other embodiments may be described.

### RELATED APPLICATIONS

None.

### BACKGROUND

The subject matter described herein relates generally to the field of electronic computing and more particularly to a locality aware work runtime scheduler for parallel processing systems.

Existing scheduling systems for parallel processing machines are based on Cilk-like runtime systems. These systems utilize randomized work stealing which can make degenerate scheduling decisions as a parallel processing system becomes larger. Work-stealing schedulers attribute a data structure, usually a double ended queue (also called a deque), to each execution unit that contain the tasks to be executed by that execution unit (which we will also call an ‘executor’). As executors generate more tasks, they push these tasks into their local attributed data-structure for subsequent processing. When an executor finishes a task it is currently executing and needs something else to do, it will first attempt to obtain work from its local deque. If the local deque is empty, it will look to ‘steal’ work from a random victim (i.e., another executor). This stealing usually occurs in a First-In-First-Out (FIFO) manner in order to reduce the synchronization contention on the victim's data-structure.

Existing work stealing schedulers utilize randomized stealing which is done in a way that ignores data-locality. As multiprocessor systems scale in size memory latency becomes an increasingly important source of overall system latency. Accordingly systems and methods to manage work stealing in multiprocessor schedulers may find utility.

### BRIEF DESCRIPTION OF THE DRAWINGS

The detailed description is described with reference to the accompanying figures.

FIGS. 1-2 are schematic, block diagram illustration of an electronic device which may be adapted to implement a locality aware work stealing runtime scheduler in accordance with various embodiments discussed herein.

FIG. 3 is a flowchart illustrating operations in a method to implement a locality aware work stealing runtime scheduler in accordance with various embodiments discussed herein.

FIG. 4 is pseudocode illustrating operations in a method to implement a locality aware work stealing runtime scheduler in accordance with various embodiments discussed herein.

FIGS. 5-7 are flowcharts illustrating operations in a method to implement a locality aware work stealing runtime scheduler in accordance with various embodiments discussed herein.

FIG. 8 is pseudocode illustrating operations in a method to implement a locality aware work stealing runtime scheduler in accordance with various embodiments discussed herein.

FIGS. 9-12 are schematic, block diagram illustration of an electronic device which may be adapted to implement a locality aware work stealing runtime scheduler in accordance with various embodiments discussed herein.

### DETAILED DESCRIPTION

Described herein are exemplary systems and methods to implement locality aware work stealing in runtime scheduling. The systems and methods described herein address two main components of a work stealing algorithm. The first component addresses where a task created by an executor should be pushed. The second component addresses how an executor should pick a task to steal.

In some embodiments the work stealing algorithm pushes a task created by an executor based at least in part upon where the dependencies of that task are located. A ‘center-of-mass’ computation may be applied to determine where a task created by an executor should be pushed. By way of example, given a task which has N data dependencies (where a data dependency is defined as the task using the data in its computation, either through writing or reading), each of these N dependencies may be denoted as force vectors which have a magnitude related to the size and access pattern of the data. Thus, the magnitude is related to the number of bits that the task will use from the data dependency. A resultant force may be determined to provide the center-of-mass of the data dependencies. The center-of-mass may then be discretized to the set of executors on the machine, e.g., by picking the executor closest to the center of mass. The scheduler pushes tasks to the executors closest to the center-of-mass in order to minimize the eventual data-movement when the pushed task executes. Specifically, the center-of-mass calculation is computed using the natural machine hierarchy (e.g., board, socket, core). Using a multi-socket system as an example, if most of a task's data is clustered on one socket, that task will be pushed to a core on that socket; then, if most of the task's data within that socket is clustered on one core, the task will be pushed to that core.

The second component of the algorithm describes procedures implemented when an executor needs to find work. When an executor becomes idle, the executor will first try to find work on its local deque. If the executor is unsuccessful, it will pick a victim that is nearby following the machine hierarchy: (i.e., core, socket, board, etc.) thereby increasing its chances of finding work that also has high data-locality with itself. The executor will also select the task (or tasks) to be stolen, rather than picking the first one in FIFO order. Two heuristics may be used to select tasks to be stolen from a victim's task deque. The first heuristic will be referred to as “altruistic stealing” in which the executor steals tasks whose dependencies' center-of-mass is furthest from the victim to help with the costly bringing-in of data as the victim is performing useful work, hence the name ‘altruistic’. By contrast, in a ‘selfish stealing’ model an executor chooses to steal tasks whose dependencies' center-of-mass' is closest to the executor, hence the name ‘selfish’.

A task as used herein has a set of data dependencies and an “ideal” core on to which execute. The ideal core may refer to the core that minimizes the weighted cost of data movement computed based on distance, data-size and data access pattern. A data dependency has a location, which refers to the place where the data is located. Location may be defined with respect to the hierarchy of the machine (for example, core-local memory, socket-local memory, socket-local DRAM, etc). A data dependency also has a size and, with respect to each task accessing it, it also has a data-access pattern.

The machine on which the task executes may be considered as a hierarchy (tree-like) of cores (executors). The cores form the leaves of the hierarchy and the intermediate nodes of the tree represent the grouping of those cores. Memories are placed at the leaves (next to the cores) or also at the intermediate node (for example a shared memory between various cores). A “distance” exists between the cores and the memories. The distance is related to the energy (or cycles) that it takes to move a bit between a core and memory. Memory that is close to the core will be cheaper energy-wise than far away memory.

In the following description, numerous specific details are set forth to provide a thorough understanding of various embodiments. However, it will be understood by those skilled in the art that the various embodiments may be practiced without the specific details. In other instances, well-known methods, procedures, components, and circuits have not been illustrated or described in detail so as not to obscure the particular embodiments.

FIGS. 1-2 are schematic, block diagram illustration of a processing system 100 which may be adapted to implement a locality aware work stealing runtime scheduler in accordance with various embodiments discussed herein. The system 100 may include one or more processors 102-1 through 102-N (generally referred to herein as “processors 102” or “processor 102”). The processors 102 may communicate via an interconnection network or bus 104. Each processor may include various components some of which are only discussed with reference to processor 102-1 for clarity. Accordingly, each of the remaining processors 102-2 through 102-N may include the same or similar components discussed with reference to the processor 102-1.

In an embodiment, the processor 102-1 may include one or more processor cores 106-1 through 106-M (referred to herein as “cores 106” or as an executor in the context of the description of the scheduler), a shared cache 108, a router 110, and/or a processor control logic or unit 120. The processor cores 106 may be implemented on a single integrated circuit (IC) chip. Moreover, the chip may include one or more shared and/or private caches (such as cache 108), buses or interconnections (such as a bus or interconnection network 112), memory controllers, or other components.

The processor cores 106 may comprise local cache memory 116-1 through 116-M (referred to herein as cache 116) and comprise task scheduler logic 118-1 through 118-M (referred to herein as task scheduler logic 118). The task scheduler logic 118 may implement operations, described below, to assign a task to one or more cores 106 and to steal a task from one or more cores 106 when the core 106 has available computing bandwidth.

In one embodiment, the router 110 may be used to communicate between various components of the processor 102-1 and/or system 100. Moreover, the processor 102-1 may include more than one router 110. Furthermore, the multitude of routers 110 may be in communication to enable data routing between various components inside or outside of the processor 102-1.

The shared cache 108 may store data (e.g., including instructions) that are utilized by one or more components of the processor 102-1, such as the cores 106. For example, the shared cache 108 may locally cache data stored in a memory 114 for faster access by components of the processor 102. In an embodiment, the cache 108 may include a mid-level cache (such as a level 2 (L2), a level 3 (L3), a level 4 (L4), or other levels of cache), a last level cache (LLC), and/or combinations thereof. Moreover, various components of the processor 102-1 may communicate with the shared cache 108 directly, through a bus (e.g., the bus 112), and/or a memory controller or hub. As shown in FIG. 1, in some embodiments, one or more of the cores 106 may include a level 1 (L1) cache 116-1 (generally referred to herein as “L1 cache 116”).

FIG. 2 illustrates a block diagram of portions of a processor core 106 and other components of a computing system, according to an embodiment of the invention. In one embodiment, the arrows shown in FIG. 2 illustrate the flow direction of instructions through the core 106. One or more processor cores (such as the processor core 106) may be implemented on a single integrated circuit chip (or die) such as discussed with reference to FIG. 1. Moreover, the chip may include one or more shared and/or private caches (e.g., cache 108 of FIG. 1), interconnections (e.g., interconnections 104 and/or 112 of FIG. 1), control units, memory controllers, or other components.

As illustrated in FIG. 2, the processor core 106 may include a fetch unit 202 to fetch instructions (including instructions with conditional branches) for execution by the core 106. The instructions may be fetched from any storage devices such as the memory 114. The core 106 may also include a decode unit 204 to decode the fetched instruction. For instance, the decode unit 204 may decode the fetched instruction into a plurality of uops (micro-operations).

Additionally, the core 106 may include a schedule unit 206. The schedule unit 206 may perform various operations associated with storing decoded instructions (e.g., received from the decode unit 204) until the instructions are ready for dispatch, e.g., until all source values of a decoded instruction become available. In one embodiment, the schedule unit 206 may schedule and/or issue (or dispatch) decoded instructions to an execution unit 208 for execution. The execution unit 208 may execute the dispatched instructions after they are decoded (e.g., by the decode unit 204) and dispatched (e.g., by the schedule unit 206). In an embodiment, the execution unit 208 may include more than one execution unit. The execution unit 208 may also perform various arithmetic operations such as addition, subtraction, multiplication, and/or division, and may include one or more an arithmetic logic units (ALUs). In an embodiment, a co-processor (not shown) may perform various arithmetic operations in conjunction with the execution unit 208.

Further, the execution unit 208 may execute instructions out-of-order. Hence, the processor core 106 may be an out-of-order processor core in one embodiment. The core 106 may also include a retirement unit 210. The retirement unit 210 may retire executed instructions after they are committed. In an embodiment, retirement of the executed instructions may result in processor state being committed from the execution of the instructions, physical registers used by the instructions being de-allocated, etc.

The core 106 may also include a bus unit 114 to enable communication between components of the processor core 106 and other components (such as the components discussed with reference to FIG. 1) via one or more buses (e.g., buses 104 and/or 112). The core 106 may also include one or more registers 216 to store data accessed by various components of the core 106 (such as values related to power consumption state settings).

Furthermore, even though FIG. 1 illustrates the control unit 120 to be coupled to the core 106 via interconnect 112?, in various embodiments the control unit 120 may be located elsewhere such as inside the core 106, coupled to the core via bus 104, etc.

Having described various embodiments and configurations of electronic devices which may be adapted to implement a locality aware work stealing runtime scheduler methods. In some embodiments the task schedulers 118 may comprise logic which, when executed, implements a locality aware work stealing runtime scheduler. Operations of the task schedulers will be described with reference to FIGS. 3-8.

Referring to FIG. 3, at operation 310 an application executing on a processing system such as the processing system 100 creates a new task for execution by one or more of the cores 106 in the processing system. At operations 315-320 the task scheduler 118 on a core 106 which is acting as the executor for the scheduling task initiates a loop which computes a weighted distance of all dependencies of the task for each executor in the processing system, and at operation 325 the task scheduler 118 pushes the task to the executor which has the minimum weighted distance to the task, i.e., the executor which is closest to the center of mass.

Operations 320-325 are explained in greater detail in FIGS. 4 and 5. FIG. 4 is pseudocode illustrating operations 315-325, and FIG. 5 is a flowchart illustrating operations involved in computing weighted dependencies. Broadly, the operations depicted in FIG. 5 describe a process by which the task scheduler 118 traverses a hierarchical tree structure in which the nodes on the tree are representative of processing cores (i.e., executors) on the machine on which the application is executing and locates the node on the tree which has the highest location weight. Referring to FIG. 5, at operation 520 the task scheduler considers a location of a dependency, and at operation 525 the task scheduler 118 adds a weight of the dependency to a location weight for the node. If, at operation 530, the location weight for the node is greater than the location weight of the node's siblings, then control passes to operation 535 and the task manager 118 informs the parent of the current node that the current child node is the heaviest child in the parent's hierarchy. At operation 540 the task manager sets the current location back to the parent node.

If, at operation 545 the parent node represents the root node of the tree, then control passes to operation 550 and the process ends. By contrast, if at operation 545 the parent node does not represent the root node of the tree then control passes back to operation 525 and the process continues to evaluate the parents in the tree. Thus, the operations depicted in FIG. 5 enable the task manager to traverse the hierarchical tree which represents the machine on which the application is executing and to determine which node in the tree has the maximum weight, and the executor which has the minimum distance may be determined as the node closest to the maximum weight. Pseudocode for performing this is presented in FIG. 4.

Once the weighted distances have been determined in FIG. 5 the task manager 118 may assign the task to an executor by traversing the tree and assigning the task to the node on the tree which is a leaf node and which has the heaviest child, as determined in operation 535. Referring to FIG. 6, at operation 610 the task manager 118 starts by setting the execution location to the root node of the tree. If, at operation 615 the location is a leaf node then control passes to operation 620 and the task is pushed to the current node. By contrast, if at operation 615 the location is not a leaf node then control passes to operation 625 and the task manager descends the tree hierarchy by setting the location to the heaviest child of the current node. Control then passes back to operation 615. Thus, operations 615-625 define a loop which traverses the tree and sets the execution location to the leaf node in the tree with the heaviest location weight.

In operation, an executor which has computational bandwidth and no work on its local work queue may steal work from another executor in the system. In conventional nomenclature the executor which steals work may be referred to as a thief, while the executor from which work is stolen may be referred to as a victim. In accordance with embodiments described herein a thief may select a task to steal from a victim using either an altruistic algorithm or a selfish algorithm. FIG. 7 is a flowchart which illustrates operations in a method for an executor which is acting as a thief to steal a task from a victim, according to embodiments. Referring to FIG. 7, at operations 710-720 the thief evaluates each task in the victim's deque and determines a task weight for the thief in the case of a selfish algorithm or the victim in the case of an altruistic algorithm (operation 715). If at operation 720 the task weight for the current task is not better than the task weight for the current best task, then control passes back to operation 715 and the next task is evaluated. By contrast, if at operation 720 the task weight for the current task is not better than the task weight for the previous task, then control passes to operation 725 and the current task is set as the best task to steal. Operations 715-725 are repeated until the task with the highest task weight is identified as the best task to steal. Control then passes to operation 730 and the thief steals the best task. FIG. 8 is pseudocode which illustrates one implementation of the operations depicted in FIG. 7.

In some embodiments, one or more of the components discussed herein can be embodied as a System On Chip (SOC) device. FIG. 9 illustrates a block diagram of an SOC package in accordance with an embodiment. As illustrated in FIG. 9, SOC 902 includes one or more Central Processing Unit (CPU) cores 920, one or more Graphics Processor Unit (GPU) cores 930, an Input/Output (I/O) interface 940, and a memory controller 942. Various components of the SOC package 902 may be coupled to an interconnect or bus such as discussed herein with reference to the other figures. Also, the SOC package 902 may include more or less components, such as those discussed herein with reference to the other figures. Further, each component of the SOC package 902 may include one or more other components, e.g., as discussed with reference to the other figures herein. In one embodiment, SOC package 902 (and its components) is provided on one or more Integrated Circuit (IC) die, e.g., which are packaged into a single semiconductor device.

As illustrated in FIG. 9, SOC package 902 is coupled to a memory 960 (which may be similar to or the same as memory discussed herein with reference to the other figures) via the memory controller 942. In an embodiment, the memory 960 (or a portion of it) can be integrated on the SOC package 902.

The I/O interface 940 may be coupled to one or more I/O devices 970, e.g., via an interconnect and/or bus such as discussed herein with reference to other figures. I/O device(s) 970 may include one or more of a keyboard, a mouse, a touchpad, a display, an image/video capture device (such as a camera or camcorder/video recorder), a touch screen, a speaker, or the like.

FIG. 10 illustrates a computing system 1000 that is arranged in a point-to-point (PtP) configuration, according to an embodiment of the invention. In particular, FIG. 10 shows a system where processors, memory, and input/output devices are interconnected by a number of point-to-point interfaces. The operations discussed with reference to FIG. 2 may be performed by one or more components of the system 1000.

As illustrated in FIG. 10, the system 1000 may include several processors, of which only two, processors 1002 and 1004 are shown for clarity. The processors 1002 and 1004 may each include a local memory controller hub (MCH) 1006 and 1008 to enable communication with memories 1010 and 1012. MCH 1006 and 1008 may include the memory controller 120 and/or logic 125 of FIG. 1 in some embodiments.

In an embodiment, the processors 1002 and 1004 may be one of the processors 102 discussed with reference to FIG. 1. The processors 1002 and 1004 may exchange data via a point-to-point (PtP) interface 1014 using PtP interface circuits 1016 and 1018, respectively. Also, the processors 1002 and 1004 may each exchange data with a chipset 1020 via individual PtP interfaces 1022 and 1024 using point-to-point interface circuits 1026, 1028, 1030, and 1032. The chipset 1020 may further exchange data with a high-performance graphics circuit 1034 via a high-performance graphics interface 1036, e.g., using a PtP interface circuit 1037.

As shown in FIG. 10, one or more of the cores 106 and/or cache 108 of FIG. 1 may be located within the processors 1002 and 1004. Other embodiments of the invention, however, may exist in other circuits, logic units, or devices within the system 1000 of FIG. 10. Furthermore, other embodiments of the invention may be distributed throughout several circuits, logic units, or devices illustrated in FIG. 10.

The chipset 1020 may communicate with a bus 1040 using a PtP interface circuit 1041. The bus 1040 may have one or more devices that communicate with it, such as a bus bridge 1042 and I/O devices 1043. Via a bus 1044, the bus bridge 1043 may communicate with other devices such as a keyboard/mouse 1045, communication devices 946 (such as modems, network interface devices, or other communication devices that may communicate with the computer network 1003), audio I/O device, and/or a data storage device 948. The data storage device 1048 (which may be a hard disk drive or a NAND flash based solid state drive) may store code 1049 that may be executed by the processors 1002 and/or 1004.

The various computing devices described herein may be a embodied as a server, desktop computer, laptop computer, tablet computer, cell phone, smartphone, personal digital assistant, game console, Internet appliance, mobile internet device or other computing device. The processor and memory arrangements represents a broad range of processor and memory arrangements including arrangements with single or multi-core processors of various execution speeds and power consumptions, and memory of various architectures (e.g., with one or more levels of caches) and various types (e.g., dynamic random access, FLASH, and so forth).

FIG. 11 is a schematic illustration of an exemplary electronic device 1100 which may be adapted to implement battery power management as described herein, in accordance with some embodiments. In one embodiment, electronic device 1100 includes one or more accompanying input/output devices including a display 1102 having a screen 1104, one or more speakers 1106, a keyboard 1110, and a mouse 1114. In various embodiments, the electronic device 1100 may be embodied as a personal computer, a laptop computer, a personal digital assistant, a mobile telephone, an entertainment device, or another computing device.

The electronic device 1100 includes system hardware 1120 and memory 1130, which may be implemented as random access memory and/or read-only memory. A power source such as a battery 1180 may be coupled to the electronic device 1100.

System hardware 1120 may include one or more processors 1122, one or more graphics processors 1124, network interfaces 1126, and bus structures 1128. In one embodiment, processor 1122 may be embodied as an Intel® Core2 Duo® processor available from Intel Corporation, Santa Clara, Calif., USA. As used herein, the term “processor” means any type of computational element, such as but not limited to, a microprocessor, a microcontroller, a complex instruction set computing (CISC) microprocessor, a reduced instruction set (RISC) microprocessor, a very long instruction word (VLIW) microprocessor, or any other type of processor or processing circuit.

Graphics processor(s) 1124 may function as adjunct processor that manages graphics and/or video operations. Graphics processor(s) 1124 may be integrated onto the motherboard of electronic device 1100 or may be coupled via an expansion slot on the motherboard.

In one embodiment, network interface 1126 could be a wired interface such as an Ethernet interface (see, e.g., Institute of Electrical and Electronics Engineers/IEEE 802.3-2002) or a wireless interface such as an IEEE 802.11a, b or g-compliant interface (see, e.g., IEEE Standard for IT-Telecommunications and information exchange between systems LAN/MAN—Part II: Wireless LAN Medium Access Control (MAC) and Physical Layer (PHY) specifications Amendment 4: Further Higher Data Rate Extension in the 2.4 GHz Band, 802.11G—2003). Another example of a wireless interface would be a general packet radio service (GPRS) interface (see, e.g., Guidelines on GPRS Handset Requirements, Global System for Mobile Communications/GSM Association, Ver. 3.0.1, December 2002).

Bus structures 1128 connect various components of system hardware 1128. In one embodiment, bus structures 1128 may be one or more of several types of bus structure(s) including a memory bus, a peripheral bus or external bus, and/or a local bus using any variety of available bus architectures including, but not limited to, 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

Memory 1130 may store an operating system 1140 for managing operations of electronic device 1100. In one embodiment, operating system 1140 includes a hardware interface module 1154, e.g., a device driver, that provides an interface to system hardware 1120. In addition, operating system 1140 may include a file system 1150 that manages files used in the operation of electronic device 1100 and a process control subsystem 1152 that manages processes executing on electronic device 1100.

Operating system 1140 may include (or manage) one or more communication interfaces that may operate in conjunction with system hardware 1120 to transceive data packets and/or data streams from a remote source. Operating system 1140 may further include a system call interface module 1142 that provides an interface between the operating system 1140 and one or more application modules resident in memory 1130. Operating system 1140 may be embodied as a UNIX operating system or any derivative thereof (e.g., Linux, Solaris, etc.) or as a Windows® brand operating system, or other operating systems.

In some embodiments memory 1130 may store one or more applications which may execute on the one or more processors 1122 including one or more task schedulers 1162. These applications may be embodied as logic instructions stored in a tangible, non-transitory computer readable medium (i.e., software or firmware) which may be executable on one or more of the processors 1122. Alternatively, these applications may be embodied as logic on a programmable device such as a field programmable gate array (FPGA) or the like. Alternatively, these applications may be reduced to logic that may be hardwired into an integrated circuit.

In some embodiments electronic device 1100 may comprise a low-power embedded processor, referred to herein as a controller 1170. The controller 1170 may be implemented as an independent integrated circuit located on the motherboard of the system 1100. In some embodiments the controller 1170 may comprise one or more processors 1172 and a memory module 1174, and the task scheduler(s) 1162 may be implemented in the controller 1170. By way of example, the memory module 1174 may comprise a persistent flash memory module and the task scheduler(s) 1162 may be implemented as logic instructions encoded in the persistent memory module, e.g., firmware or software. Because the controller 1170 is physically separate from the main processor(s) 1122 and operating system 1140, the adjunct controller 1170 may be made secure, i.e., inaccessible to hackers such that it cannot be tampered with.

FIG. 12 is a schematic illustration of another embodiment of an electronic device 1200 which may be adapted to which may be adapted to implement battery power management as described herein, according to embodiments. In some embodiments electronic device 1200 may be embodied as a mobile telephone, a personal digital assistant (PDA), a laptop computer, or the like. Electronic device 1200 may include one or more temperature sensors 1212, an RF transceiver 1220 to transceive RF signals and a signal processing module 1222 to process signals received by RF transceiver 1220.

RF transceiver 1220 may implement a local wireless connection via a protocol such as, e.g., Bluetooth or 802.11X. IEEE 802.11a, b or g-compliant interface (see, e.g., IEEE Standard for IT-Telecommunications and information exchange between systems LAN/MAN—Part II: Wireless LAN Medium Access Control (MAC) and Physical Layer (PHY) specifications Amendment 4: Further Higher Data Rate Extension in the 2.4 GHz Band, 802.11G—2003). Another example of a wireless interface would be a general packet radio service (GPRS) interface (see, e.g., Guidelines on GPRS Handset Requirements, Global System for Mobile Communications/GSM Association, Ver. 3.0.1, December 2002).

Electronic device 1200 may further include one or more processors 1224 and a memory module 1240. As used herein, the term “processor” means any type of computational element, such as but not limited to, a microprocessor, a microcontroller, a complex instruction set computing (CISC) microprocessor, a reduced instruction set (RISC) microprocessor, a very long instruction word (VLIW) microprocessor, or any other type of processor or processing circuit. In some embodiments, processor 1224 may be one or more processors in the family of Intel® PXA27x processors available from Intel® Corporation of Santa Clara, Calif. Alternatively, other CPUs may be used, such as Intel's Itanium®, XEON·, ATOM™, and Celeron® processors. Also, one or more processors from other manufactures may be utilized. Moreover, the processors may have a single or multi core design.

In some embodiments, memory module 1240 includes volatile memory (RAM); however, memory module 1240 may be implemented using other memory types such as dynamic RAM (DRAM), synchronous DRAM (SDRAM), and the like. Memory 1240 may store one or more applications which execute on the processor(s) 1222.

Electronic device 1200 may further include one or more input/output interfaces such as, e.g., a keypad 1226 and one or more displays 1228. In some embodiments electronic device 1200 comprises one or more camera modules 1220 and an image signal processor 1232, and speakers 1234. A power source such as a battery 1270 may be coupled to electronic device 1200.

In some embodiments electronic device 1200 may include a controller 1270 which may be implemented in a manner analogous to that of adjunct controller 170, described above. In the embodiment depicted in FIG. 12 the controller 1270 comprises one or more processor(s) 1272 and a memory module 1274, which may be implemented as a persistent flash memory module. Because the controller 1270 is physically separate from the main processor(s) 1224, the controller 1270 may be made secure, i.e., inaccessible to hackers such that it cannot be tampered with.

In some embodiments at least one of the memory 1230 or the controller 1270 may comprise one or more task scheduler(s) 162, which may be implemented as logic instructions encoded in the persistent memory module, e.g., firmware or software.

The following examples pertain to further embodiments.

Example 1 is a computer program product comprising logic instructions stored in a non-transitory computer readable medium which, when executed by a processor, configure the processor to perform operations to assign a task to a processor in a system comprising a plurality of processors. The operations comprise determining a center of mass of a plurality of data dependencies associated with a task and assigning the task to a processor in the system which is closest to the center of mass.

The logic instructions may further configure the processor to perform operations comprising assigning a force vector to each data dependency associated with the task, wherein the force vector has a magnitude that is a function of an amount of data associated with the task and an access pattern of data associated with the task and determining a resultant force for the task from the force vector for each data dependency.

The logic instructions may further configure the processor to perform operations comprising determining a location weight for each node in a task tree and selecting the node in the task tree which has the highest location weight.

The logic instructions may further configure the processor to perform operations comprising placing the task into a data structure associated with the processor which is closest to the center of mass.

The logic instructions may further configure the processor to perform operations comprising determining that the processor has idle capacity, and in response to a determination that the processor has idle capacity, selecting a victim from which to steal a task based at least in part on a proximity of the victim to the processor.

Selecting a task to steal from the victim may be performed using an altruistic algorithm to steal a task from a victim which has the smallest weight for the victim. Alternatively, selecting a task to steal from the victim may be performed using an selfish algorithm to steal a task from a victim which has the largest weight for the stealing processor.

In example 2 an electronic device comprises a plurality of processing cores, wherein at least one of the processing cores comprises logic to determine a center of mass of a plurality of data dependencies associated with a task, wherein the center of mass has a minimum weighted distance to the task and to assign the task to a processor in the system which is closest to the center of mass.

At least one of the processing cores may further comprise logic to assign a force vector to each data dependency associated with the task, wherein the force vector has a magnitude that is a function of an amount of data associated with the task and an access pattern of data associated with the task; and determine a resultant force for the task from the force vector for each data dependency.

At least one of the processing cores may further comprise logic to determine a location weight for each node in a task tree and select the node in the task tree which has the highest location weight.

At least one of the processing cores may further comprise logic to place the task into a data structure associated with the processor which is closest to the center of mass.

At least one of the processing cores may further comprise logic to determine that the processor has idle capacity and in response to a determination that the processor has idle capacity, to select a victim from which to steal a task based at least in part on a proximity of the victim to the processor.

Selecting a task to steal from the victim may be performed using an altruistic algorithm to steal a task from a victim which has the smallest weight for the victim. Alternatively, selecting a task to steal from the victim may be performed using an selfish algorithm to steal a task from a victim which has the largest weight for the stealing processor.

In example 3, a method to assign a task to a processor in a system comprising a plurality of processors, comprises determining a center of mass of a plurality of data dependencies associated with a task and assigning the task to a processor in the system which is closest to the center of mass.

The method may further comprise assigning a force vector to each data dependency associated with the task, wherein the force vector has a magnitude that is a function of an amount of data associated with the task and an access pattern of data associated with the task and determining a resultant force for the task from the force vector for each data dependency.

The method may further comprise determining a location weight for each node in a task tree and selecting the node in the task tree which has the highest location weight.

The method may further comprise placing the task into a data structure associated with the processor which is closest to the center of mass.

The method may further comprise determining that the processor has idle capacity and in response to a determination that the processor has idle capacity selecting a victim from which to steal a task based at least in part on a proximity of the victim to the processor.

Selecting a task to steal from the victim may be performed using an altruistic algorithm to steal a task from a victim which has the smallest weight for the victim. Alternatively, selecting a task to steal from the victim may be performed using an selfish algorithm to steal a task from a victim which has the largest weight for the stealing processor.

The terms “logic instructions” as referred to herein relates to expressions which may be understood by one or more machines for performing one or more logical operations. For example, logic instructions may comprise instructions which are interpretable by a compiler for executing one or more operations on one or more data objects. However, this is merely an example of machine-readable instructions and embodiments are not limited in this respect.

The terms “computer readable medium” as referred to herein relates to media capable of maintaining expressions which are perceivable by one or more machines. For example, a computer readable medium may comprise one or more storage devices for storing computer readable instructions or data. Such storage devices may comprise storage media such as, for example, optical, magnetic or semiconductor storage media. However, this is merely an example of a computer readable medium and embodiments are not limited in this respect.

The term “logic” as referred to herein relates to structure for performing one or more logical operations. For example, logic may comprise circuitry which provides one or more output signals based upon one or more input signals. Such circuitry may comprise a finite state machine which receives a digital input and provides a digital output, or circuitry which provides one or more analog output signals in response to one or more analog input signals. Such circuitry may be provided in an application specific integrated circuit (ASIC) or field programmable gate array (FPGA). Also, logic may comprise machine-readable instructions stored in a memory in combination with processing circuitry to execute such machine-readable instructions. However, these are merely examples of structures which may provide logic and embodiments are not limited in this respect.

Some of the methods described herein may be embodied as logic instructions on a computer-readable medium. When executed on a processor, the logic instructions cause a processor to be programmed as a special-purpose machine that implements the described methods. The processor, when configured by the logic instructions to execute the methods described herein, constitutes structure for performing the described methods. Alternatively, the methods described herein may be reduced to logic on, e.g., a field programmable gate array (FPGA), an application specific integrated circuit (ASIC) or the like.

In the description and claims, the terms coupled and connected, along with their derivatives, may be used. In particular embodiments, connected may be used to indicate that two or more elements are in direct physical or electrical contact with each other. Coupled may mean that two or more elements are in direct physical or electrical contact. However, coupled may also mean that two or more elements may not be in direct contact with each other, but yet may still cooperate or interact with each other.

Reference in the specification to “one embodiment” or “some embodiments” means that a particular feature, structure, or characteristic described in connection with the embodiment is included in at least an implementation. The appearances of the phrase “in one embodiment” in various places in the specification may or may not be all referring to the same embodiment.

Although embodiments have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. A computer program product comprising logic instructions stored in a non-transitory computer readable medium which, when executed by a processor, configure the processor to perform operations to assign a task to a processor in a system comprising a plurality of processors, comprising:
determining a center of mass of a plurality of data dependencies associated with a task; and
assigning the task to a processor in the system which is closest to the center of mass.

2. The computer program product of claim 1, further comprising logic instructions stored in the non-transitory computer readable medium which, when executed by the processor, configure the processor to perform operations comprising:
assigning a force vector to each data dependency associated with the task, wherein the force vector has a magnitude that is a function of an amount of data associated with the task and an access pattern of data associated with the task; and
determining a resultant force for the task from the force vector for each data dependency.

3. The computer program product of claim 2, further comprising logic instructions stored in the non-transitory computer readable medium which, when executed by the processor, configure the processor to perform operations comprising:
determining a location weight for each node in a task tree; and
selecting the node in the task tree which has the highest location weight.

4. The computer program product of claim 1, further comprising logic instructions stored in the non-transitory computer readable medium which, when executed by the processor, configure the processor to perform operations comprising:
place the task into a data structure associated with the processor which is closest to the center of mass.

5. The computer program product of claim 1, further comprising logic instructions stored in the non-transitory computer readable medium which, when executed by the processor, configure the processor to perform operations comprising:
determining that the processor has idle capacity; and
in response to a determination that the processor has idle capacity:
selecting a victim from which to steal a task based at least in part on a proximity of the victim to the processor.

6. The computer program product of claim 5, wherein selecting a task to steal from the victim comprises using an altruistic algorithm to steal a task from a victim which has the smallest weight for the victim.

7. The computer program product of claim 5, wherein selecting a task to steal from the victim comprises using an selfish algorithm to steal a task from a victim which has the largest weight for the stealing processor.

8. An electronic device, comprising:
a plurality of processing cores, wherein at least one of the processing cores comprises logic to:
determine a center of mass of a plurality of data dependencies associated with a task, wherein the center of mass has a minimum weighted distance to the task; and
assign the task to a processor in the system which is closest to the center of mass.

9. The electronic device of claim 8, wherein at least one of the processing cores comprises logic to:
assign a force vector to each data dependency associated with the task, wherein the force vector has a magnitude that is a function of an amount of data associated with the task and an access pattern of data associated with the task; and
determine a resultant force for the task from the force vector for each data dependency.

10. The electronic device of claim 9, wherein at least one of the processing cores comprises logic to:
determine a location weight for each node in a task tree; and
select the node in the task tree which has the highest location weight.

11. The electronic device of claim 9, wherein at least one of the processing cores comprises logic to:
place the task into a data structure associated with the processor which is closest to the center of mass.

12. The electronic device of claim 9, wherein at least one of the processing cores comprises logic to:
determine that the processor has idle capacity; and
in response to a determination that the processor has idle capacity:
select a victim from which to steal a task based at least in part on a proximity of the victim to the processor.

13. The electronic device of claim 12 wherein selecting a task to steal from the victim comprises using an altruistic algorithm to steal a task from a victim which has the smallest weight for the victim.

14. The electronic device of claim 12, wherein selecting a task to steal from the victim comprises using an selfish algorithm to steal a task from a victim which has the largest weight for the stealing processor.

15. A method to assign a task to a processor in a system comprising a plurality of processors, comprising:
determining a center of mass of a plurality of data dependencies associated with a task; and
assigning the task to a processor in the system which is closest to the center of mass.

16. The method of claim 15, further comprising:
assigning a force vector to each data dependency associated with the task, wherein the force vector has a magnitude that is a function of an amount of data associated with the task and an access pattern of data associated with the task; and
determining a resultant force for the task from the force vector for each data dependency.

17. The method of claim 15, further comprising:
determining a location weight for each node in a task tree; and
selecting the node in the task tree which has the highest location weight.

18. The method of claim 15, further comprising:
placing the task into a data structure associated with the processor which is closest to the center of mass.

19. The method of claim 15, further comprising:
determining that the processor has idle capacity; and
in response to a determination that the processor has idle capacity:
selecting a victim from which to steal a task based at least in part on a proximity of the victim to the processor.

20. The method of claim 19 wherein selecting a task to steal from the victim comprises using an altruistic algorithm to steal a task from a victim which has the smallest weight for the victim.

21. The method of claim 19, wherein selecting a task to steal from the victim comprises using an selfish algorithm to steal a task from a victim which has the largest weight for the stealing processor.
